(19) United States
(12) Patent Application Publication
(10) Pub. No.: US 2009/0161791 A1
(43) Pub. Date: Jun. 25, 2009

(54) Transmitter Using Linear Space-Time Codes For Wide-Band and/or Low-SNR Multiple-Antenna Wireless Communication Systems And Method Of Using Same

(75) Inventor: Mehrdad Shamsi KHOUZANI, North York (CA)

Correspondence Address: GROSSMAN, TUCKER, PERREAULT & PFLEGER, PLLC, 55 SOUTH COMMERICAL STREET, MANCHESTER, NH, 03101, US

(73) Assignee: CARTIZA CANADA INC., Ottawa (CA)

(21) Appl. No.: 12/340,182

(22) Filed: Dec. 19, 2008

(30) Foreign Application Priority Data
Dec. 21, 2007 (CA) 2616387

(51) Int. Cl. H04L 27/00

(52) U.S. Cl. 375/295

(57) ABSTRACT

A linear space-time LST encoder in a transmitter transmitting data over a wireless communications channel. Data are distributed over plural transmit antennas, plural time intervals, or both, according to a space-time matrix containing LST codes. The encoder comprises means for splitting each block of information bits into q equal length sub-blocks; means for mapping each sub-block to a symbol sᵢ, i=1, . . . q, from a complex constellation; means for calculating a set of t×m dispersion matrices Aᵢ for sending a signal

$$S = {\sum }_{i = 1}^{q} {A}_{i} {s}_{i}$$

over t time slots and m transmit antennas; means for selecting a slope S₀ of the wireless communications channel capacity. The slope S₀ being a function of the dispersion matrices Aᵢ, and optimizing S₀ for providing an optimized set of dispersion matrices under a power efficient transmission system constraint.

### BACKGROUND OF THE INVENTION

1. Field of the Invention

This invention relates generally to a method of designing linear space-time (LST) codes that are suitable for information transmission over a multiple-antenna system operating in a wide-band and/or low signal-to-noise (SNR) environment. The method is based on optimizing the low-SNR capacity slope of multiple-antenna systems using linear space-time (LST) codes. The capacity-slope of LST-coded systems S₀ depends on the number of the dispersion matrices specifying a particular LST code, and the number of receive antennas. An upper-bound on S₀ is realistically achievable by an appropriate estimate of dispersion matrices while some necessary and sufficient conditions are defined. Based on these conditions S₀ is maximized and LST codes with excellent error performance are computed.

2. Related Art

Reliability of wireless transmission/reception is at high price in the existing time varying multipath fading environment. The next generation of wireless systems use transmit diversity to provide high data rate services with high quality. For example, by using two antennas at the transmitter site the diversity order of the wireless communication system doubles and equals the diversity order of a maximal-ratio receiver combining MRRC system with one transmit and two receive antennas.

Most conventional wireless communications systems use a single transmit antenna and a single receive antenna. Bit rate improvements are evident when using multiple-antenna arrays for transmission, reception, or both. The use of multiple-antenna for transmission can mitigate fading effects and increase data transmission rates in a propagation channel of given characteristics. Further on, by using multiple-antenna for reception additional advantages may be obtained at the receiving site. When multiple-antenna are used at both the transmitter and the receiver sites, the wireless channel is a multiple-input multiple-output MIMO channel.

In the past few years, space-time coding has emerged as a tool for exploiting the huge capacity of multiple-antenna systems as well as introducing diversity into wireless communication systems operating in a fading environment. In the space-time modulation technique, data are transmitted as codewords. A codeword is represented by a matrix. Codewords are distributed across the antenna array in space, and in time as each element of the antenna array transmits a complex amplitude within a symbol interval. The sum of concurrent transmission of amplitudes during one symbol interval is referred to as a channel use.

Mathematical models are extensively used to model the propagation channel between transmit/receive antennas and include matrix of channel coefficients used to relate the amplitude of the received signal to the amplitude of the transmitted signal. Such coefficients are constantly updated based on measurements of the pilot signals.

Linear space-time (LST) codes are arguably among the most successful space-time codes. Many existing space-time coding schemes can be categorized as LST codes. Aside from being high-rate, LST codes are easily encodable and have decoding algorithms with reasonable complexity. In LST-coded systems, the transmitter maps the information bits to symbols from an appropriate constellation and disperses a block of symbols across differing time and antenna elements by computing a linear combination of the symbols based on a set of preselected dispersion matrices.

The most widely used criteria for designing space-time codes are diversity advantage and coding gain. The diversity advantage is reflected in the asymptotic slope of the error probability curve versus signal-to-noise ratio (SNR). The coding gain does not affect the asymptotic slope but results in a shift in the curves. In designing LST codes, maximization of the mutual information between the input and the output of the channel is considered as another criterion for optimizing the LST code performance.

It is also worth noting that the two popular design criteria, namely diversity advantage and coding gain, are derived from the known high-SNR analysis of the decoding error probability. In the real world however, most multiple-antenna systems operate in low-SNR regimes. For example, in a typical wireless cellular network most users are in geographical locations with very low-SNR. For such low-SNR environments, theoretic tools are used to gain insight in designing power-efficient transmission/reception schemes. Optimal trade off between rate, power, and bandwidth allocation is of prime importance in low-SNR and/or wide-band regimes.

### SUMMARY OF THE INVENTION

Accordingly, it is a general object of the present invention to provide an improved method for designing LST codes based on studying the behavior of the capacity of an LST-coded system at low-SNR operating points. The channel capacity is expressed as a function of

$$\frac{{E}_{b}}{{N}_{0}} ,$$

representing the energy per bit normalized to the noise power. Denoting this function by

$$C ( \frac{{E}_{b}}{{N}_{0}} ) ,$$

the transmission rate should satisfy R/B_{w}≦C(P/RN₀), where B_{w} is the bandwidth of the channel and P is the transmission power. It is known, that in low-SNR and/or wide-band regimes

$$C ( \frac{{E}_{b}}{{N}_{0}} )$$

can be approximated by an affine function of log

$$( \frac{{E}_{b}}{{N}_{0}} ) .$$

The key performance measure in low-SNR regimes is the slope S₀ of this affine function and its interception with the zero-capacity line denoted by

$$\frac{{E}_{b}}{{N}_{0 min}} .$$

Both parameters are critical to improving communications quality and can be computed from the traditional notion of capacity expressed as a function of SNR. While the

$$\frac{{E}_{b}}{{N}_{0 min}}$$

line depends on the first derivative of this function at zero SNR, the slope S₀ depends both on the first and the second derivative therein. Knowing

$$\frac{{E}_{b}}{{N}_{0 min}}$$

and S₀ is of a great practical importance, as the required bandwidth to sustain a desired rate at a given power can be easily estimated, through an approximation of the function

$$C ( \frac{{E}_{b}}{{N}_{0}} ) .$$

Optimizing S₀ for a given transmission scheme is also of practical value especially in low-power regimes, because deviations from an optimal value may incur significant bandwidth penalty.

In accordance with one aspect of the present invention, there is provided a method for gesigning optimized LST codes in a wireless transmitter having a limited power (P). First

$$\frac{{E}_{b}}{{N}_{0 min}}$$

and S₀ for LST-coded systems are computed. S₀ is then expressed as a function of the pre-determined dispersion matrices of the code and the number of receive antennas in the system. Finally an upper-bound on S₀ is established and made realistically achievable based on pre-established necessary and sufficient conditions. Based on these conditions pre-established based on the practical needs of the transmission/reception process, a simplified method for optimizing S₀ is devised that results in LST codes, e.g. the Σ₃ code, with very good error performance, exceeding the performances of the best known fully-diverse codes.

Optimizing the capacity-slope for LST-coded systems is considered for a practical case t/m≦q≦mt in a wireless communications system having m transmit antennas, q symbols per code matrix, n receive antennas, and t channel uses. As seen, this practical solution imposes no limitation on the number of the transmit or receive antennas.

Appropriate dispersion matrices are estimated based on an iterative process which starts with the generation of B which is an mt×q random complex matrix; B is then updated and replaced with B(B*B)^{-1/2}; next, B is re-shaped to obtain D which is a t×mq complex matrix based on the relation of B and D with the dispersion matrices given by B=[Â₁ Â₂ . . . Â_{q}] and D=[A₁ A₂ . . . A_{q}].

Similarly to B above, D is next updated and replaced with (DD*)^{-1/2} D, and re-shaped to obtain a new B based on the same relation of Band D with the dispersion matrices.

Then we check how psuedo-unitary B and D are, and for imposing psuedo-unitaryness on a matrix we have to make ξ(B) and ξ(D) as close to 1 as possible based on verifying equations ξ(B)−1>ε or ξ(D)−1>ε, for some ε>0 of choice and repeat the process until ξ(B) and ξ(D) become close enough to 1 and equations ξ(B)−1>ε or ξ(D)−1>ε are satisfied. Parameter ε>0 controls how close to 1 we want ξ(B) and ξ(D) to be.

Finally, the last new B is scaled to comply with the power constraint.

The new transmitter using the inventive LST encoder according to the invention provides an excellent error performance in either wide-band systems, or low-SNR systems, while imposing low decoding complexity.

Advantageously, the present invention optimizes the LST codes for differing configurations of the t, m, q, values at the transmitting site and imposes no limitation on either number of the transmit antennas or the receive antennas in a multiple-stream, multiple-antennas MIMO system.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the accompanying drawings, in which:

FIG. 1 is a block diagram of a multiple-stream, multiple-antenna transmitter in an LST-coded wireless communications system that may be used to implement the invention.

FIG. 2 is a flow chart illustrating an iterative process for optimizing the capacity-slope of the LST-coded wireless communication system of FIG. 1.

FIG. 3 illustrates convergence behavior of ξ(D) and ξ(B); with 4×4 code matrices, and q=8 symbols per code matrix.

FIG. 4 illustrates the bit error rate vs. received

$$\frac{{E}_{b}}{{N}_{0}}$$

for both a slope-optimized code Σ₄ and a fully-diverse code Δ₄, m=4 transmit antennas, n=2 receive antennas, q=8 symbols per code matrix, 16QAM.

FIG. 5 illustrates the bit error rate vs. received

$$\frac{{E}_{b}}{{N}_{0}}$$

for both a slope-optimized code Σ₂ and a Golden code Γ₂; m=2 transmit antennas, n=2 receive antennas, q=4 symbols per code matrix, 16QAM.

FIG. 6 illustrates channel capacity

$$C ( \frac{{E}_{b}}{{N}_{0}} )$$

vs. received signal

$$\frac{{E}_{b}}{{N}_{0}}$$

for both a slope-optimized code Σ₃ and a fully-diverse code P₃, m=3 transmit antennas, n=1 receive antenna, q=3 symbols per code matrix, 16QAM.

FIG. 7 illustrates the bit error rate vs. received signal

$$\frac{{E}_{b}}{{N}_{0}}$$

for both a slope-optimized code Σ₃ and a fully-diverse code P₃, m=3 transmit antennas, n=1 receive antenna, q=3 symbols per code matrix, 16QAM.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an explanation of a novel transmitter using the LST codes of the present invention.

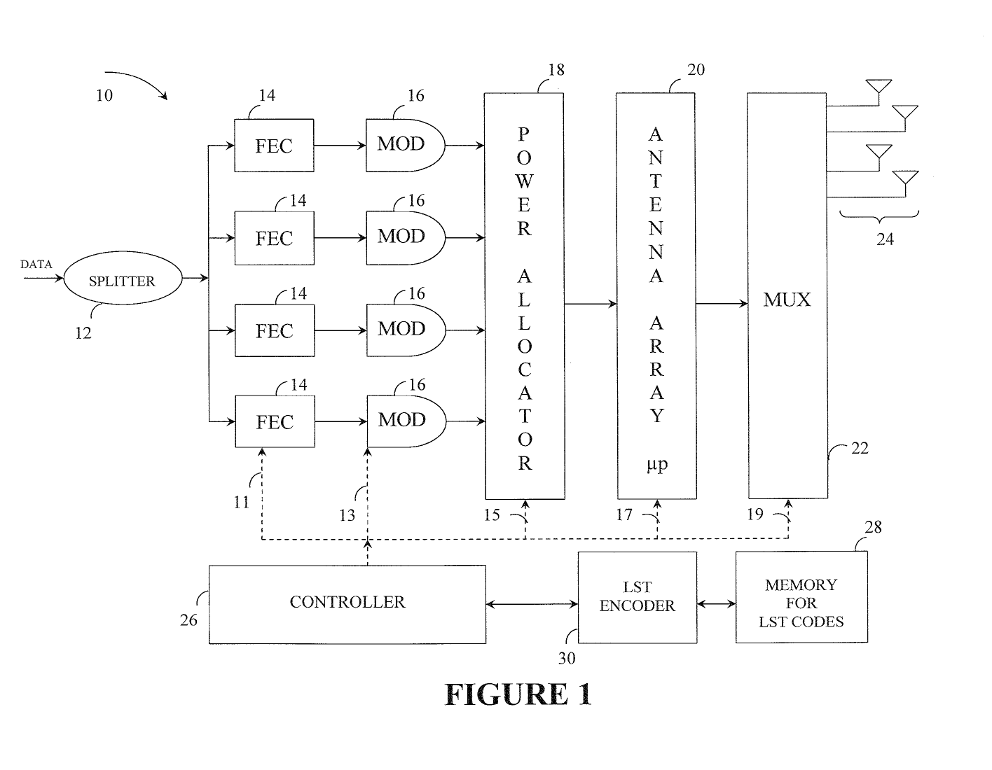

Turning now to the drawings, FIG. 1 is a block diagram of a multiple-stream, multiple-antenna transmitter 10 in an LST-coded wireless communications system that may be used to implement the invention.

Splitter 12 receives user data and separates the received data into a number of data streams based on a pre-established ratio under the supervision of controller 26. The data streams are inputted into error corrections encoders FEC 14 based on control signal 11 indicating the type and the rate of encoding. The output of encoders 14 is coupled to modulators 16 including all variety of modulations (amplitude and phase) as indicated by control signal 13. The output of the modulators 16 is coupled to a power allocator 18 which allocates power to various data streams based on the available power and control signal 15.

The output of the power allocator 18 is coupled to an antenna array microprocessor 20 which processes the data streams by applying LST codes received with control signal 17. The LST codes are generated by LST encoder 30 and systematically stored in memory 28. By applying the LST codes, each data stream is coded for transmission with a different antenna pattern after being multiplexed at 22 and delivered to antenna array 24.

Antenna arrays are used to increase the capacity of wireless communications systems. At the transmitter, each antenna of the array transmits a signal with a specific gain and phase relationship with the other antenna signals.

Similarly, arrays of antennas may be used at the receiving site. When multiple antennas are used at both transmitting and receiving sites, the established wireless channel is referred to as a multiple-input multiple-output MIMO channel.

The transmitter 10 may be used in a MIMO channel, with m transmit antennas, m being an integer of at least 2, and n receive antennas. As mentioned before, by using the inventive encoder 30 and the new LST-codes differing with configurations at the transmit site does not impose any limitations on the number of receive antennas n.

### Encoder (30) and LST-Codes Computation

### Notations

log(.) and logₑ(.) denote logarithm in base 2 and in base e, respectively; X denotes the set of complex numbers;

XN(0,a) is the zero-mean, circularly symmetric, complex Gaussian random variable with variance a;
Iₖ is the k×k identity matrix;
A [symbol] B is the Kronecker product of two given matrices A, B.

Given a matrix A, its vector form, denoted by Â, is obtained by stacking up its columns one after another.

The transpose and conjugate transpose of A are denoted by A^{T} and A*, respectively.

The trace and the determinant of A is Tr(A) and det(A), respectively. Tr(AB)=Tr(BA) for any two matrices A, B whose product is a square matrix. E[x] denotes the expected value of a random variable x.

The trace and the expectation operators are interchangeable, i.e., Tr(E[.])=E[Tr(.)].

### Affine Approximation of

$$C ( \frac{{E}_{b}}{{N}_{0}} )$$

Traditionally, the channel capacity of a communication channel has been expressed as a function of SNR. However, the inventor will express the capacity as a function of energy per information bit normalized to the noise power to provide better engineer insight and practical guidelines based on theoretical findings especially for communication over wideband channels and/or in low-SNR environments.

A linear Gaussian channel has an input xεX^{m×1}, and an output yεX^{n×1} related through:

y=Hx+w,

where HεX^{n×m} is the channel matrix, and

w is the noise vector with independent XN(0,N₀)-distributed components.

Such a relation models a wide variety of channels depending on the interpretation of the channel matrix and the input vector.

This invention focusses on multiple-antenna communication channels where the channel matrix H represents the path gains between different receive and transmit antennas.

It is further assumed that:

For a given power constraint on E[x*x], we can define SNR as ρ=E[x*x]/N₀, where N₀=E[w*w]/n, and

C(ρ) the capacity of the channel as a function of SNR.

The transmitter uses a capacity achieving distribution, and the normalized energy per information bit is given by

$$\frac{{E}_{b}}{{N}_{0}} = ρ / C ( ρ ) .$$

Channel optimization is performed by estimating the maximum achievable rate for a given

$$\frac{{E}_{b}}{{N}_{0}} .$$

The inventor has started this optimization by expressing the channel capacity as a function of

$$\frac{{E}_{b}}{{N}_{0}} ,$$

denoted by

$$C ( \frac{{E}_{b}}{{N}_{0}} ) ,$$

and approximated by:

$$C ( \frac{{E}_{b}}{{N}_{0}} ) \approx {S}_{0} ( log ( \frac{{E}_{b}}{{N}_{0}} ) - log ( \frac{{E}_{b}}{{N}_{0 min}} ) ) , \qquad ( 1 )$$

which is an affine function of log

$$( \frac{{E}_{b}}{{N}_{0}} ) .$$

This approximation becomes more accurate as

$$\frac{{E}_{b}}{{N}_{0}} -> \frac{{E}_{b}}{{N}_{0 min}}$$

(equivalent to SNR→0).
It turns out that the channel capacity

$$\frac{{E}_{b}}{{N}_{0 min}}$$

and the slope of the channel capacity curve S₀ are given by:

$$\frac{{E}_{b}}{{N}_{0 min}} = \frac{1}{\dot{C} ( 0 )} , {S}_{0} = \frac{{2 [ \dot{C} ( 0 ) ]}^{2}}{- \ddot{C} ( 0 )} . \qquad ( 2 )$$

### LST-Coded Systems

### The Canonical Channel Assumption

A multiple stream, multiple-antenna system has m transmit and n receive antennas operating in a quasi-static Rayleigh fading environment with Gaussian noise and modeled as:

Y=SH+W, (3)

where SεX^{t×m} and YεX^{t×n} are transmitted and received matrices, respectively. The noise WεX^{t×n} has independent entries that are XN(0,N₀)-distributed. The channel matrix is HεX^{n×m} includes entries that are independent and XN(0,1)-distributed. The channel matrix H is constant over a block of t channel uses and independently changes to a new value in the next block. The receiver knows the channel, but the transmitter does not.
We refer to this channel as the canonical channel.

The LST encoder takes each block of information bits and breaks it to q equal length sub-blocks and maps each resulting sub-block to a symbol sᵢ, i=1, . . . , q, from a complex constellation. The encoder then computes the corresponding code matrix using,

$$S = {\sum }_{i = 1}^{q} {A}_{i} {s}_{i } \qquad ( 4 )$$

where Aᵢ's are t×m dispersion matrices, and sends S over t time slots and m transmit antennas according to the following relation between the input and the output of the channel:

$$Y = {\sum }_{i = 1}^{q} {s}_{i} {A}_{i} H + W , \qquad ( 5 )$$

which can be rewritten in vector form as:

Ŷ=(H^{T} [symbol] Iₜ)Bs+Ŵ, (6)

where B:=[Â₁Â₂ . . . , Â_{q}] and s:=(s₁, s₂, . . . , s_{q})^{T}.

The equivalent channel matrix is defined as:

H:=(H^{T} [symbol] Iₜ)B, (7)

and rewritten in vector form as: Ŷ=Hs+Ŵ.
It is evident that H simplifies to:

$$H = [ \begin{matrix}{A}_{1} {h}_{1} & {A}_{2} {h}_{1} & … & {A}_{q} {h}_{1} \\ {A}_{1} {h}_{2} & {A}_{2} {h}_{2} & … & {A}_{q} {h}_{2} \\ ⋮ & ⋮ & ⋱ & ⋮ \\ {A}_{1} {h}_{n} & {A}_{2} {h}_{n} & … & {A}_{q} {h}_{n}\end{matrix} ] , \qquad ( 8 )$$

where hᵢ denotes the i^{th} column of the matrix H.

In the real world, the transmitter has a limited power specified by the following constraints:

$$E = [ {\vert {s}_{i} \vert}^{2} ] \leq P , {\sum }_{i = 1}^{q} Tr ( {A}_{i}^{*} {A}_{i} ) = Tr ( {B}^{*} B ) = γ < ∞ .$$

In this setting, the maximum rate that can be achieved by an uncorrelated input vector s is given by:

$$C = \frac{1}{t} E [ log det ( {I}_{q} + \frac{P}{{N}_{0}} {H}^{*} H ) ] , \qquad ( 9 )$$

and it is achieved when the components of s are XN(0,P)-distributed.

The signal-to-noise ratio ρ is now defined as:

$$ρ := \frac{E [ Tr ( {S}^{*} S ) ]}{{N}_{0}} = \frac{γ P}{{N}_{0}} ,$$

and C is expressed as a function of ρ:

$$C ( ρ ) = \frac{1}{t} E [ log det ( {I}_{q} + \frac{ρ}{γ} {H}^{*} H ) ] . \qquad ( 10 )$$

As mentioned before, the capacity expressed as a function of

$$\frac{{E}_{b}}{{N}_{0}}$$

in a logarithmic scale can be approximated by an affine function which is fully defined by its slope S₀ and its intercept

$$\frac{{E}_{b}}{{N}_{0 min}} .$$

These two parameters are computed as the first and the second derivative of C(ρ) at ρ=0.
Computing Ċ(0) is straightforward.
Auxiliary lemmas are introduced for computing \dot{Ċ}(0).

Lemma 1 For the canonical channel, the first derivative of C(ρ) at ρ=0 is given by.

$$\dot{C} ( 0 ) = \frac{n}{t} log e \qquad ( 11 )$$

From Lemma 1 we find the intercept

$$\frac{{E}_{b}}{{N}_{0 min}}$$

to be:

$$\frac{{E}_{b}}{{N}_{0 min}} = \frac{t}{n} {log}_{e} 2. \qquad ( 12 )$$

\dot{Ċ}(0) will verify the following:

$$\ddot{C} ( 0 ) = \frac{1}{t {γ}^{2}} E [ Tr ( {( H \text{*} H )}^{2} ) ] log e , \qquad ( 13 )$$

which means the main task here is to compute E[Tr((H*H)²)].

Lemma 2 Let AεX^{k×k} be a Hermitian matrix, and hεX^{k×1} be a random vector whose components hᵢ, i=1, . . . , k, are independent and XN(0,1)-distributed.

Then, we have:

E[(h*Ah)²]=Tr²(A)+Tr(A²). (14)

Lemma 3 Let AεX^{k×k} be an arbitrary matrix, and hεX^{k×1} be a random vector whose components are independent and XN(0,1)-distributed. Then, we have

E[|h*Ah|²]=Tr(AA*)+Tr(A)Tr(A*). (15)

We can now compute E[Tr((H*H)²)].

Proposition 4 Let H be the tn×q channel matrix and assume that hᵢ's are n-dimensional vectors with independent XN (0,1)-distributed components.

Then, we have:

$$E [ Tr ( {( H \text{*} H )}^{2} ) ] = {\sum }_{i = 1}^{q} {\sum }_{j = 1}^{q} [ nTr ( {A}_{i}^{*} {A}_{j} {A}_{j}^{*} {A}_{i} ) + {n}^{2} Tr ( {A}_{i}^{*} {A}_{j} ) Tr ( {A}_{j}^{*} {A}_{i} ) ] . \qquad ( 16 )$$

Using Proposition 4 and equation (13), we find the slope S₀ to be:

$${S}_{0} = \frac{2 n}{t} \frac{{[ {\sum }_{i} Tr ( {A}_{i}^{*} {A}_{i} ) ]}^{2}}{{\sum }_{i} {\sum }_{j} [ Tr ( {A}_{i}^{*} {A}_{j} {A}_{j}^{*} {A}_{i} ) + nTr ( {A}_{i}^{*} {A}_{j} ) Tr ( {A}_{j}^{*} {A}_{i} ) ]} . \qquad ( 17 )$$

The equivalent channel matrix H has two alternative representations.

Deriving the expression for the slope S₀, dispersion matrices Aᵢ's have been used. Alternatively, one can express S₀ in terms of B=[Â₁ Â₂ . . . Â_{q}]. The benefit of this alternative expression will become clear later on when used to establish an upper-bound on S₀.

To that end,

$${[ {\sum }_{i} Tr ( {A}_{i} {A}_{i}^{*} ) ]}^{2} = {Tr}^{2} ( B \text{*} B ) , \qquad ( 18 )$$

and verify that,

$${\sum }_{i} {\sum }_{j} Tr ( {A}_{i}^{*} {A}_{j} ) Tr ( {A}_{i}^{*} {A}_{j} ) = Tr ( {( B \text{*} B )}^{2} ) . \qquad ( 19 )$$

The two expressions above take care of the nominator and the second term in the denominator of equation (17), respectively.

Next, we define matrix D as D:=[A₁ A₂ . . . A_{q},]

and use it to simplify the second term in the denominator of S₀:

$$\begin{matrix}{\sum }_{i} {\sum }_{j} Tr ( {A}_{i}^{*} {A}_{j} {A}_{j}^{*} {A}_{i} ) = {\sum }_{i} {\sum }_{j} Tr ( {A}_{i} {A}_{i}^{*} {A}_{j} {A}_{j}^{*} ) \\ = Tr ( {\sum }_{i} {\sum }_{j} {A}_{i} {A}_{i}^{*} {A}_{j} {A}_{j}^{*} ) \\ = Tr ( {\sum }_{i} {A}_{i} {A}_{i}^{*} {\sum }_{j} {A}_{j} {A}_{j}^{*} ) \\ = Tr ( {[ {\sum }_{i} {A}_{i} {A}_{i}^{*} ]}^{2} ) \\ = Tr ( {( DD \text{*} )}^{2} )\end{matrix} \qquad ( 20 )$$

Combining equations (18), (19), and (21), we can rewrite S₀ as

$${S}_{0} = \frac{2 n}{t} \frac{{Tr}^{2} ( B \text{*} B )}{Tr ( {( DD \text{*} )}^{2} ) + nTr ( {( B \text{*} B )}^{2} )} . \qquad ( 21 )$$

Unlike the expression that is obtained for intercept

$$\frac{{E}_{b}}{{N}_{{0}_{min}}} ,$$

the slope S₀ is a function of the dispersion matrices. This means that the slope of the capacity curve can be controlled by manipulating the dispersion matrices. For a power efficient transmission system, S₀ has to be as large as possible. This is achieved by optimizing S₀.

### Achievable Upper-Bound on S₀

The goal is to maximize S₀ by choosing appropriate dispersion matrices. Slope S₀ given by equation (17), is not a concave nor a convex function of Aᵢ's. This can be easily verified; for example, given a solution set to the optimization problem, one can find another solution simply by multiplying all dispersion matrices with a single unitary matrix, which in turn shows that the function is not concave.

An analytical approach is used to characterize the solution sets of the optimization problem. An upper-bound on S₀ is calculated and made relistically achievable by imposing certain structure on the dispersion matrices.

We use (22) along with Definition 5 and an auxiliary Lemma 6, to obtain the main result.

Definition 5 A matrix XεX^{k×1} is said to be pseudo-unitary if X*X=αI or XX*−αI for some α>0.

Lemma 6 Let XεX^{k×1} be a matrix.

Define ξ(X) as:

$$ξ ( X ) := \frac{min \{ k , l \} Tr ( {( XX \text{*} )}^{2} )}{{Tr}^{2} ( XX \text{*} )} .$$

Then, ξ(X) satisfies

ξ(X)≦1, (22)

with equality if and only if X is pseudo-unitary.

Proposition 7 The slope S₀ is upper-bounded by

$${S}_{0} \leq \frac{2 n}{t} \frac{min \{ t , mq \} min \{ q , mt \}}{min \{ q , mt \} + n min \{ t , mq \}} . \qquad ( 23 )$$

with equality if and only if D and B are pseudo-unitary.

As clearly stated in Proposition 7, the slope S₀ is maximized when D and B are psuedo-unitary. Notice that B and D are constructed from the dispersion matrices of the code i.e.,

B=[Â₁ Â₂ . . . Â_{q}] and D=[A₁ A₂ . . . A_{q}].

The parameter ξ(X) is a measure of psuedo-unitariness of a given matrix X. As stated in Lemma 6, a matrix is psuedo-unitary if and only if ξ(X)=1. Therefore, in our numerical method for optimizing S₀, we try to impose psuedo-unitariness on B and D by forcing ξ(B) and ξ(D) to be equal to 1. As stated repeatedly in the disclosed invention, the optimization S₀ through B and D improves the performance of the code. In doing so, we in fact designed the dispersion matrices of the code.

Proposition 7 not only gives an upper-bound on S₀, but also shows that the upper-bound is achievable by carefully designed codes. It is also worth noting that although the maximum value of S₀ depends on the number of receive antennas n in the system, the maximized set of dispersion matrices, representing the optimal code, is independent of the number n.

Therefore, in contrast with the prior art design procedures, the present invention provides optimized LST codes irrespective of the number of antennas n the receiver has. This is of practical interest especially in down-link transmission to satisfy users equipped with differing numbers of receive antennas.

The Optimal Slope Selection

Depending on q, m, and t, the optimized slope takes on different values as summarized in the following corollary.

Corollary 8 The optimized slope is given by:

$${S}_{0 , optim} = \{ \begin{matrix}2 mn / ( m + n ) ; & q \geq mt \\ 2 nq / ( nt + q ) ; & t / m \leq q < mt \\ 2 mnq / ( tmn + t ) ; & q < t / m\end{matrix} \qquad ( 24 )$$

Considering Proposition 7 it suffices to enforce pseudo-unitary constraints on matrices B and D in order to optimize S₀. The pseudo-unitary condition on B translate into BB*=βI or B*B=βI depending on whether B is a tall or a wide matrix. The same is true for D.

Three situations arise from equation (24):

Situation-1: q≧mt: matrices B and D are both wide.

As known, by setting BB*=βI with an appropriate β chosen according to the power constraint, one can make the capacity of the equivalent channel of the LST-coded system equal to that of the original multiple-antenna channel.

This choice of B automatically enforces DD*=αI (for some α>0), hence maximizes S₀. However, there are many situations in the field where choosing q≧mt is not possible due to limited computational power or limited number of the receive antennas. Similarly, to be able to use at the receiving site a sphere decoding or successive nulling-and-canceling decoding algorithm, we must have q≦nt. This choice when combined with q≧mt implies n≧m, i.e., the number of the receive antennas should be greater than or equal to the number of the transmit antennas, which is not always possible.

In Situation-1, the optimized S₀ is given by S_{0,optim}=2 mn/(m+n), which is the maximum achievable capacity-slope of a multiple-antenna system with m transmit and n receive antennas but at the same time imposing the un-necessary constraint n>m. This solution is practically un-acceptable.

Situation-2: q<t/m: matrices B and D are both tall.

The pseudo-unitary constraint are B*B=βI and D*D=αI, which lead to the following value for the optimized slope: S_{0,optim}=2 mnq/(tmn+ft). This case is not of practical interest because of long encoding and decoding delays.

Situation-3: t/m≦q<mt: matrix D is wide but matrix B is tall.

The pseudo-unitary constraint on B takes on the form B*B=βI. Similarly, the pseudo-unitary constraint on D is given by DD*=αI.
In this case, the optimized slope is S_{0,optim}=2 nq/(nt+q).
Most practical LST-coded systems fall into this category. This solution is selected to generate an optimal LST code (Σ).

* For selecting the optimal value S₀ the pseudo-unitary constraints on B and D have to be enforced in the sequel. To that end, we need the following support from linear algebra.

Lemma 9 Let XεX^{k×1} be a full-rank matrix. Assume that l>k (respectively, l≦k), and set Z:=(XX*)^{-1/2} X (respectively, Z:=X(X*X)^{-1/2}).

Then ZZ*=I (respectively, Z*Z=I).

This result Then ZZ*=I (respectively, Z*Z=I) is used in an iterrative process to determine optimal S₀.

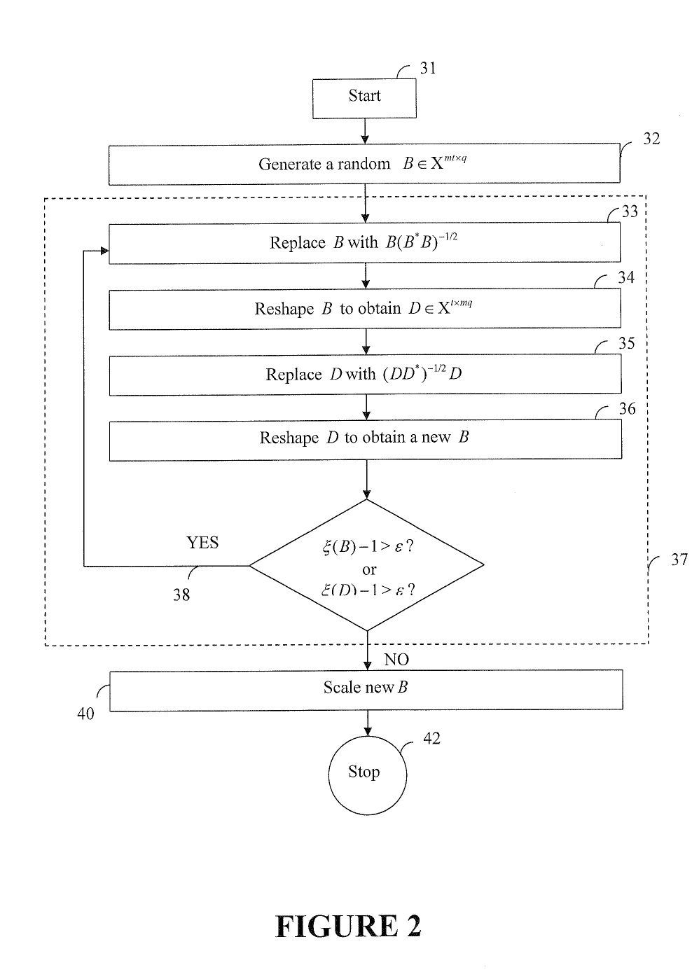

FIG. 2 is a flow chart illustrating the iterative process for optimizing the capacity-slope of the LST-coded wireless communication system of FIG. 1. The iterative process for optimizing S₀ in FIG. 2 is based on engineered constraints.

We only consider cases in Situation-3 satisfying t/m≦q<mt, which are of practical value. The process starts at 31.

In step 32: Generate a random B, BεX^{mt×q};

In step 33: Replace B with: B(B*B)^{-1/2};
In step 34: Reshape B to obtain D, DεX^{t×mq};
In step 35: Replace D with: (DD*)^{-1/2} D;
In step 36: Reshape D to obtain a new B;
In step 38: If ξ(B)−1>ε or ξ(D)−1>ε, for some ε>0 of choice, go to step 33 and perform steps 33 to 36 again as an atomic transaction 37 until convergence becomes <(1+ε);
In step 40: Scale new B to comply with the power constraint and stop at 42. Use last new B as the optimized LST code.

Note that, B=[Â₁ Â₂ . . . Â_{q}] and D=[A₁ A₂ . . . A_{q}]. Therefore, Band D are related through dispersion matrices A₁ A₂ . . . A_{q}. Thus, one can easily obtain D from B or vice versa by reshaping it through the relation given above.

The parameter ε is a small number greater than zero that controls the percision of the iterative method that enforces psuedo-unitariness on B and D. For example, if we want ξ(B) and ξ(D) to be less than 0.0001 away from 1, we will choose ε=0.0001.

As stated above, we scale B to comply with the power constraint imposed on the code. For example, if the power constraint is given by Tr(B*B)=γ, we scale B by a factor equal to γ/Tr(B*B).

### Simulation Results

The performances of optimized LST codes according to the invention have been compared in simulators with existing LST codes. Optimizing the set of dispersion matrices for optimal S₀ is the criterion for designing LST codes when transmitting q symbols in t time slots over a system with m transmit antennas and n receive antennas. As such, S₀ is optimized for different configurations of the t, m, q values at the transmitting site.

At the receiving site, the sphere decoding algorithm was used in all simulations, where channel coefficients are assumed to be block-fading and the Rayleigh distribution known to the receiver but not the transmitter.

During simulations, almost all LST codes calculated based on the inventive process have at least the same or slightly better performance than the fully-diverse LST codes with same configuration of t, m, q.

Imposing a full-diversity condition on space-time codes is one the common ways of ensuring their good performance. Our invention shows better, or close performance when compared to fully-diverse codes, despite the fact that it is not fully-diverse. This means that without imposing any additional restricting condition on the structure of the code, our inventive codes have very good performance. Thus the designer has the freedom to further optimize and tune the inventive LST codes based on other design criteria.

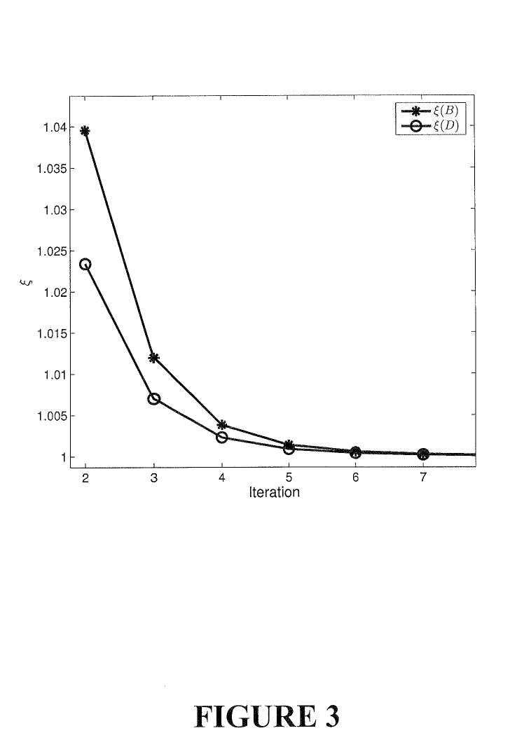

FIGS. 3 to 7 are presented for comparing the simulation results with known transmission/reception wireless systems using fully diverse codes.

Comparison with Fully Diverse Codes

In the first experiment, we design an LST code for a system with design parameter t=4, m=4, q=8, n=2. FIG. 3 shows the convergence behavior of ξ(D) and ξ(B) as the iterration process proceeds. As shown, both ξ(D) and ξ(B) rapidly converge to one, which is the minimum value, resulting in a code with optimal S₀. The slope S₀ of the obtained code is 2, which is the maximum theoretical value predicted by the Corollary (25) for this configuration.

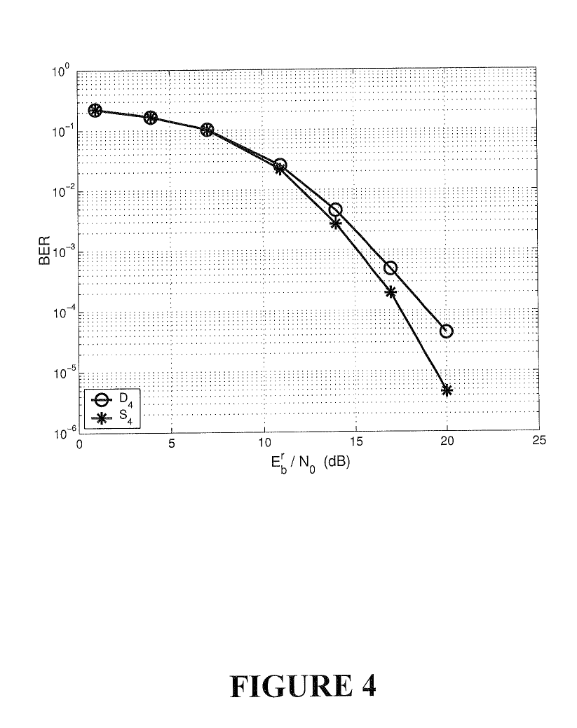

In FIG. 4, the LST code Σ₄ computed according to the present invention is compared with a known fully-diverse code Δ₄. The symbols are taken from a 16QAM constellation. As shown, the LST codes according to the invention display a slightly better performance.

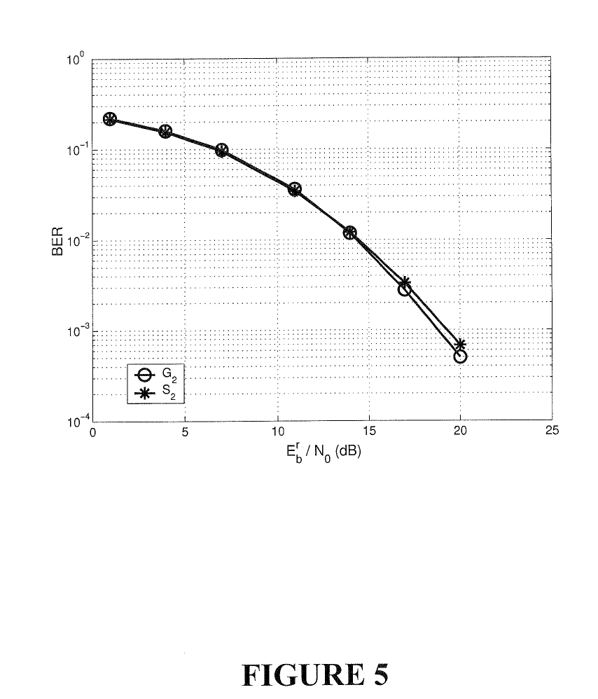

FIG. 5 shows the error performance of the code Y designed for m=2, n=2 and q=4. The B matrix of this code is given in the Appendix. This code is compared with the known fully diverse Golden code Γ₂ designed with the same m, n and q parameters. A 16QAM constellation is used. As shown, the performances of the two codes are similar and both acceptable. Both the Golden code Γ₂ and Damen's code Σ₄ have an optimized capacity-slope with performances expected to be very close to the corresponding slope-optimized LST codes according to the invention.

### Slope Optimization

To show the importance of optimizing the capacity-slope, another experiment was performed for a t=3, μm=3, q=3 and n=1 system, and results were compared with the fully diverse code P₃ (see Appendix), having the same configuration and same t, m, q and n parameters. The B matrix of this code is also given in the Appendix. Calculations results show that the capacity-slope of the Σ₃ code is equal to 1, while that of the P₃ code is 0.633, which is less than the optimal value.

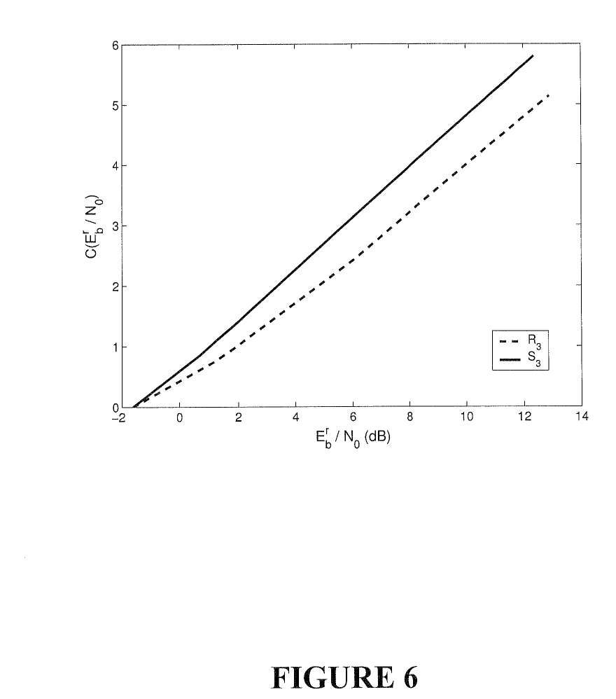

In FIG. 6, the capacity of a multiple-antenna system that uses the Σ₃ code is compared with one that uses the P₃ code. This figure clearly shows that, for a given intercept

$$\frac{{E}_{b}}{{N}_{0}} ,$$

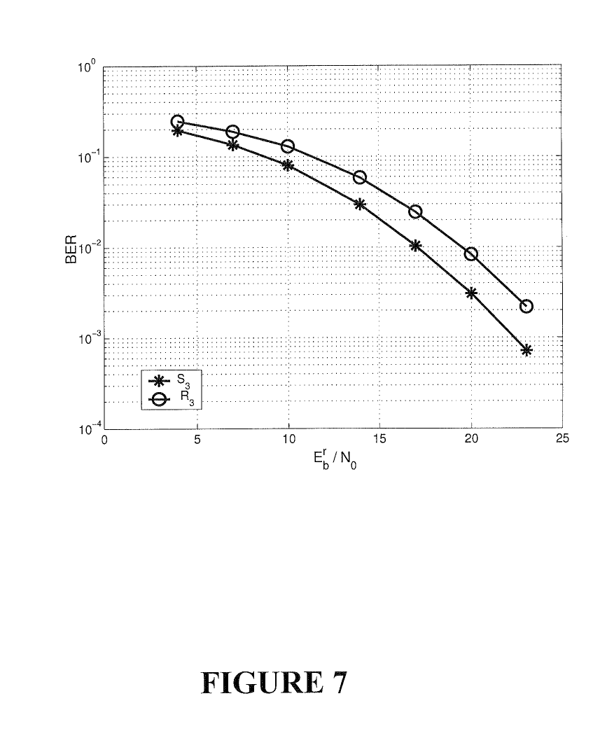

higher rates can be supported by Σ₃ than by P₃.
As shown in FIG. 7, the slope-optimized code Σ₃ clearly outperforms P₃.

More to that, note that Σ₃ is not necessarily fully diverse, while P₃ is fully diverse by construction.

The low-SNR capacity slope of an LST coded system can be computed based on pre-established, necessary and sufficient conditions to determine a slope-optimized LST code using a simplified process. The optimized LST codes have excellent error performance comparable to best existing fully-diverse codes.

As shown through simulations, the LST codes of the invention display better error performance without requiring further optimization. Such performances are also good at high-SNR, despite the fact that these LST codes are not necessarily fully diverse.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

1. A linear space-time LST encoder in a transmitter transmitting data over a wireless communications channel, said data being distributed over plural transmit antennas, plural time intervals, or both, according to a space-time matrix containing LST codes, the encoder comprising:
means for splitting each block of information bits into q equal length sub-blocks;
means for mapping each sub-block to a symbol sᵢ, i=1, . . . q, from a complex constellation;
means for calculating a set of t×m dispersion matrices Aᵢ for sending a signal
$$S = {\sum }_{i = 1}^{q} {A}_{i} {s}_{i}$$
over t time slots and m transmit antennas;
means for selecting a slope S₀ of the wireless communications channel capacity expressed as a function of energy over noise power
$$\frac{{E}_{b}}{{N}_{0}}$$
in a logarithmic scale according to an affine function, said slope S₀ being a function of the dispersion matrices Aᵢ, and optimizing S₀ for providing an optimized set of dispersion matrices under a power efficient transmission system constraint,
whereby the optimized set of dispersion matrices specifying the optimal LST code is provided independent of a number n of receive antennas by imposing a pseudo-unitary structure to matrices B=[Â₁ Â₂ . . . Â_{q}] and D=[A₁ A₂ . . . A_{q}] through an iterrative process, based on an optimal slope selection solution t/m≦q<mt, and
means for storing the optimal LST code for subsequent transmissions.

2. A method for encoding a signal at a transmitting site when transmitting q symbols in t time slots over a system with m transmit antennas and n receive antennas over a wireless communications channel using linear space-time LST codes, comprising the steps:
splitting each block of information bits into q equal length sub-blocks;
mapping each sub-block to a symbol sᵢ, i=1, . . . q, from a complex constellation;
calculating a set of t×m dispersion matrices Aᵢ for sending the signal
$$S = {\sum }_{i = 1}^{q} {A}_{i} {s}_{i}$$
over t time slots and m transmit antennas;
selecting a slope S₀ of the wireless communications channel capacity expressed as a function of energy over noise power
$$\frac{{E}_{b}}{{N}_{0}}$$
in a logarithmic scale according to an affine function,
optimizing S₀ for providing an optimized set of dispersion matrices under a power efficient transmission system constraint, said slope S₀ being a function of the dispersion matrices Aᵢ, said optimized set of dispersion matrices specifying the optimal LST code provided by imposing a pseudo-unitary structure to matrices B=[Â₁ Â₂ . . . Â_{q}] and D=[A₁ A₂ . . . A_{q}] through an iterrative process, based on an optimal slope selection at t/m≦q<mt and an optimized slope S_{0,optim}=2 nq/(nt+q), said iterrative process comprising:
(a) generate a random B, BεX^{mt×q};
(b) replace B with: B(B*B)^{-1/2};
(c) reshape B to obtain D, DεX^{t×mq};
(d) replace D with: (DD*)^{-1/2} D;
(e) reshape D to obtain a new-B;
(f) If ξ(B)−1ε or ξ(D)−1>ε, for ε>0 repeat steps (b) to (f) until convergence becomes smaller than (1+ε);
(g) scale new-B to comply with system power constraint; and
(h) store last new-B and use last new-B as the optimal LST code,
whereby S₀ is optimized for different configurations of the t, m, q values at the transmitting site, the optimal LST code being provided independent of a number n of receive antennas and without increasing receivers complexity.
